(19) United States
(12) Patent Application Publication
(10) Pub. No.: US 2006/0041425 A1
(43) Pub. Date: Feb. 23, 2006

(54) Providing personal skating music on demand at skating rinks

(76) Inventor: Joel Robert Smulson, Calabasas, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 11/188,282

(22) Filed: Jul. 23, 2005

Related U.S. Application Data
(60) Provisional application No. 60/603,879, filed on Aug. 23, 2004.

(51) Int. Cl. G10L 11/00

(52) U.S. Cl. 704/200

(57) ABSTRACT

Skating music selections personal to individual skaters are made available for on-demand playback at skating rinks. The music selections are stored as digital files and are played back through a skating rink sound system in response to skater identification input such as a personal identification number keyboard entry or by radio frequency identification tags, for example. The personal digital music files may be stored on a server and downloaded to geographically distant skating rinks for use by skaters visiting those rinks.

This application claims priority to the Aug. 23, 2004 filing date of Provisional Application No. 60/603,879.

### BACKGROUND OF THE INVENTION

1. Field of the Invention

This invention relates to a system and method for providing personalized skating music on demand at skating locations such as ice skating rinks.

2. State of the Prior Art

Figure skaters perform skating routines to musical selections of their personal choice. In the course of training and practice the skaters bring their music with them to their local ice rink, typically in the form of a cassette tape or CD recording. Skaters wait their turn to play their music recording on a cassette or CD player provided by the rink facility and connected to an existing public address sound system at the ice rink. One problem with this practice is that the cassette or CD players provided at skating rinks are subject to breakdowns and vandalism and require frequent replacement.

### SUMMARY OF THE INVENTION

In one aspect of the invention an on demand personal skating music system is provided for storing personal skating music sound tracks chosen by individual skaters and delivering the stored personal sound tracks for playback on demand at a skating rink. The personal skating music system according to this invention generally has a local storage system for storing personal digital sound tracks at the skating rink location, a local data base of skater IDs assigned to individual skaters for associating the stored sound tracks in the local storage system to corresponding individual skaters, a skater identification station for receiving skater identification input at the skating rink location, and a sound track playback system for playing back stored sound tracks. The local storage system may be a hard disk storage of a local computer at the skating rink location. The personal digital sound tracks and the local data base of skater IDs may be stored on the local storage. A software application running on the local computer calls up stored music tracks for playback over the rink's sound system on demand in response to entry of skater identification inputs.

A local sound track input station may be located on the premises of the skating rink and connected for uploading sound tracks to the local storage system. The local sound track input station may include a cassette and/or CD player connected through suitable processing circuits for converting personal sound tracks brought to the skating rink location by individual skaters on cassettes or CDs to digital sound tracks suitable for storage on the local storage system.

The skater identification station accepts a skater identification input entered by skaters visiting the skating rink location. The skater identification station is preferably installed at a location accessible to a skater on or near the skating rink, and may be in the form of a keyboard for entry of the skater identification input. The skater identification station may also take the form of a reader such as an optical, magnetic or radio frequency identification reader for reading identification cards, tags or keys appropriately encoded with skater identification data, or a biometric recognition reader such as a fingerprint or retinal scanner for associating a particular skater with a pre-assigned skater identification input.

The personal skating music system may include a playback control for controlling playback of the sound tracks at the skating rink location by the skaters or their trainers and coaches. The playback control may have one or more of pause, stop, fast forward, rewind, and repeat control functions, among other possible playback control functions. The playback control may be a hand held wireless remote control.

Digital music tracks may be queued for play back through the local sound system of each skating rink location, for example, in order according to the sequence of skater identification inputs received at the skating rink location.

In a first embodiment the skating music delivery system of this invention can be a local system installed at a single skating location. In this first embodiment all components of the system may be physically installed at the single skating location.

In a second embodiment of the invention the skating music delivery system of this invention includes one or more local systems each of which is networked to a remote file server and central sound track storage system. The remote server and central sound track storage system may be located at a server location geographically remote from any of the skating locations and connected, as over the Internet, for uploading of personal music tracks to the central storage from any of multiple skating rink locations, and for downloading of personal sound tracks from the central storage to local storage at any of the skating locations. The locally stored music tracks are then available for playback at the skating rink locations in response to skater ID input provided by skaters visiting the skating rink location or locations. The remote server location may also hold a master skater identification data base containing a combined skater identification data base for all the personal music tracks stored at the central sound track storage system.

In yet another embodiment, the personal skating music tracks music are stored in a central storage of a server which is networked to local computers at one or more skating rink locations for downloading skating music tracks to the local computers in response to skater ID input provided at those skating rink locations for immediate playback at those locations. In this last embodiment the music tracks are retrieved from the central storage over a network or internet connection in response to each skater ID input.

In alternate forms of the invention, the remote file server may also be networked, as over the Internet, for uploading of digital soundtracks to the central file storage from locations other than skating rink locations, such as music recording studios or skater's personal computers.

The invention also extends to a method for providing personal skating music for playback on demand by individual skaters at a skating rink location having the steps of assigning a unique skater identification to each of a number of skaters, storing a number of personal music tracks selected by the skaters and associating each of the personal music tracks with a corresponding unique skater identification, receiving a particular skater identification input from an individual skater present at a skating rink location and playing at least one of the personal music tracks associated with the particular skater identification input through a local sound system at the skating rink location.

The method may also have the steps of providing multiple skating locations each having a local public address sound system audible to skaters on a skating rink at each location, providing a central file storage networked for downloading digital sound tracks to any of the skating locations, storing digital sound tracks selected by skaters on the central file storage, each sound track having an associated skater identification, downloading personal sound tracks from the central storage to one or more of the skating locations, and storing the downloaded personal music tracks for subsequent playback in response to skater ID input received at the one or more skating locations.

These and other improvements, features and advantages of this invention will be better understood from the following detailed description taken in conjunction with the accompanying drawings.

### BRIEF DESCRIPTION OF THE DRAWINGS

FIG. 1 is a diagram of a typical skating location provided with a personal skating music delivery system according to this invention;

FIG. 2 is a general block diagram of a personal skating music delivery system according to this invention; and

FIG. 3 is a block diagram of a typical on demand personal skating music delivery system according to this invention adapted for servicing multiple skating locations.

### DETAILED DESCRIPTION OF THE PREFERRED EMBODIMENTS

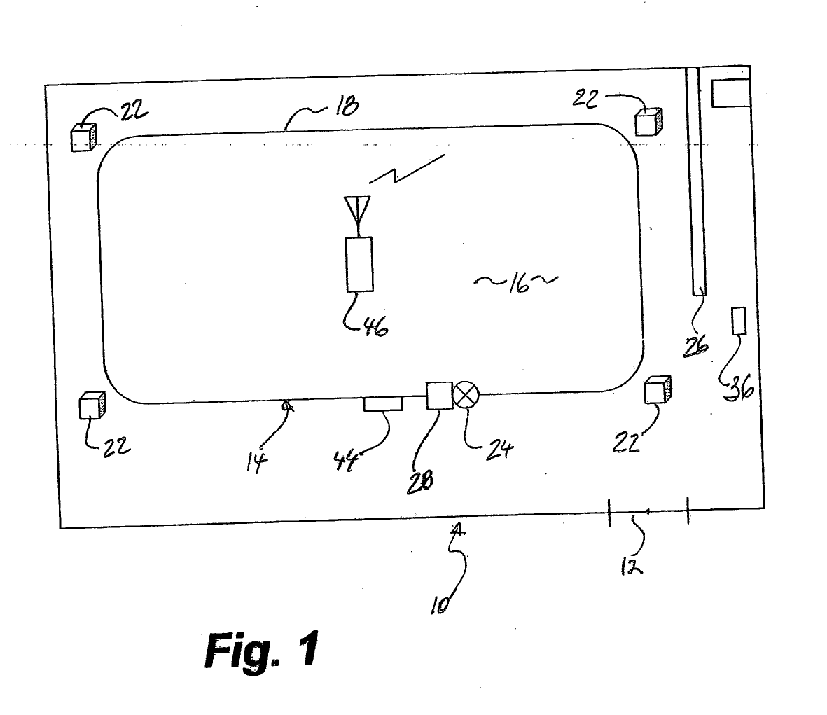

With reference to the drawings wherein like elements are designated by like numerals, FIG. 1 shows in diagram form a typical skating location generally designated by numeral 10, with a main entrance 12, a skating rink 14 with a skating surface 16 encompassed by a wall 18, and a public address sound system including four loud speakers 22 for playing skating music and making public announcements audible to skaters on the rink 14 and generally throughout the skating rink location 10. A turnstile 24 controls entry to and exit from the skating rink 14, and a service counter 26 is provided for use by rink staff attending to rink customers and skaters.

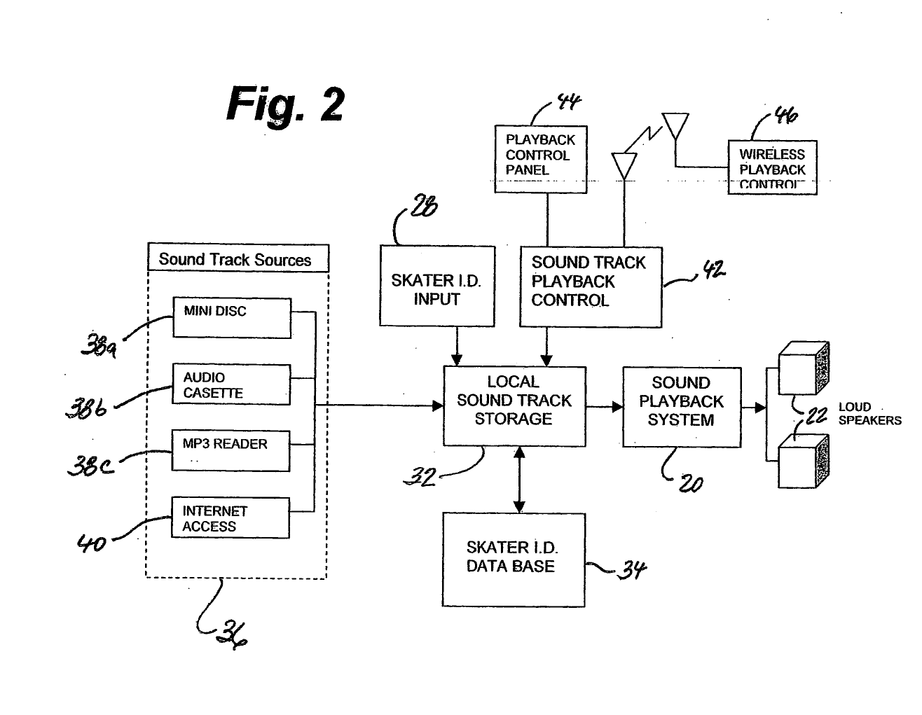

FIG. 2 is a block diagram of a personal skating music delivery system according to this invention for storing and playing personal sound tracks on demand by skaters at a skating rink location such as location 10 of FIG. 1.

In one embodiment of the invention a personal sound track file server 30 is provided at the skating location 10. The sound track file server 30, such as a suitably configured personal computer (PC), includes or is connected to a digital sound track file storage system 32 which may include mass storage media such as one or more magnetic hard discs and/or optical storage media for storing digitized sound tracks of personal skating music selections. The sound track file server 30 is connected to a sound track playback system 20 which provides digital-to-analog conversion of the stored sound track files and audio amplification for playback of the sound tracks through loud speakers 22 at the skating location 10.

The server 30 has access to a skater identification data base 34, kept for example on a magnetic data storage hard disk of the server, and containing skater ID data. Each skater ID is a data element uniquely associated with an individual skater and also associated with a personal sound track provided by that individual skater and stored on storage system 32. That is, individual skaters are associated to their chosen skating music sound tracks by way of skater IDs assigned to them at the skating rink location.

Skater IDs are typically assigned in the course of a first time visit by a particular skater to a skating location 10. In a typical transaction an individual skater arrives at a skating location 10 and provides to rink staff a personal sound track of music for use in his or her skating routine. The skater's personal sound track may be delivered in any convenient format such as a cassette tape recording, an optical mini-disc recording, or an MP3 digital file stored on a memory chip, to name a few possibilities. The staff at the skating location assigns a skater ID to the particular skater and uploads the skater's sound track to the storage system 32 where it remains associated with the assigned skater ID.

The skater ID can take the form of a sequence of characters and/or numerals unique to each individual skater. The skater ID can be encoded in a suitable portable key device such as a magnetically, optically or otherwise encoded key card or tag, or on a radio frequency identification (RFID) tag, for example. The skater ID key device is given to the skater and is used on subsequent visits to the skating location 10 by the skater to retrieve and play back that skater's personal sound track stored on the storage system 32.

A sound track input station 36 is provided at the skating location 10 and is connected for uploading personal sound tracks provided by visiting skaters to the storage system 32 for future retrieval. The sound track input station 36 may have one or more input devices for reading or playing different portable sound recording formats such as mini disc, audio cassette, and MP3 players or readers 36a, 36b, 36c. Optionally, digital personal sound tracks may be delivered to the skating rink location 10 from remote locations by skaters over a global digital communications network, such as an Internet connection 40, for uploading to the system's sound track storage system 32.

A skater identification station 28 is installed at the skating location 10. The skater identification station 28 is designed and configured for receiving a skater ID input, as by reading a skater's portable key device, and is connected for conveying the skater ID input to server 30 as part of a demand or request for playback of a personal sound track previously stored on storage system 32 and associated with that skater identification input in data base 34. The skater identification station 28 is preferably located for convenient access by a skater on or near the skating rink 14, and may take the form of a keyboard for manual entry of the skater ID input, or a reader such as an optical, magnetic or radio frequency identification reader for reading identification cards or tags, or other key device appropriately encoded with skater ID data.

The server 30 is programmed with suitable software for retrieving personal sound track files from the storage system 32 in response to skater identification input received at a skater identification station 28 and for forwarding the retrieved sound track files to the sound track sound system 20 at the skating location 10 for playback through the location's loudspeakers 22.

The system may also include a skater or coach operated playback control station 42 for controlling playback of the music sound track by sound system 20 at the skating rink location 10. For example, the playback control station may include one or more of pause, stop, fast forward, rewind, and repeat control functions. The skater operated playback control 42 may be a control panel or keyboard 44 installed at a convenient location at skating rink location 10 or a hand held wireless remote control 46 carried by the skater or by a coach or trainer overlooking the skater's routine.

In one embodiment, the skating music delivery system of this invention can be limited to a single skating location 10 with all components indicated in FIG. 2 installed at the single skating location 10.

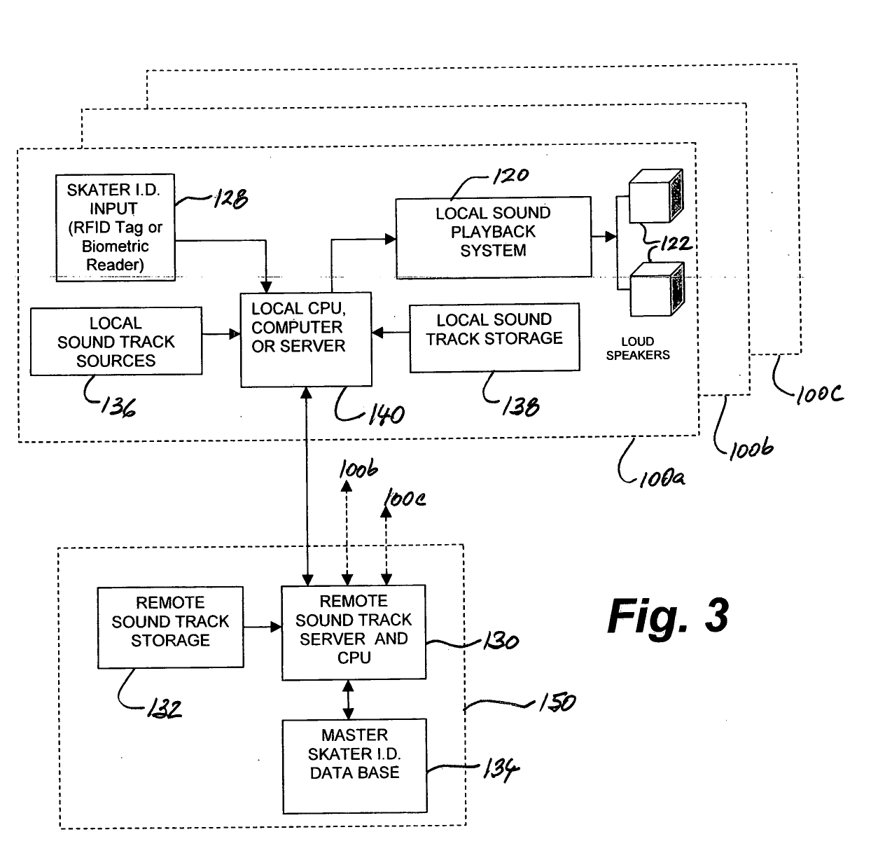

In a second embodiment illustrated in FIG. 3, a master file server computer and central sound track storage system are configured and connected for servicing multiple geographically separate skating locations. As depicted in FIG. 3 a master remote sound track server 130 and a central remote sound track storage system 132 are located at a remote central server location 150 which may be geographically remote from skating locations 100a,b,c. In this second embodiment, multiple skating locations 100a,b,c may each have a local personal music system such as described in connection with FIG. 2, but the local server 140 at each skating location is also networked to a central, remote server 130.

The remote central sound track storage system 132 is connected, as by an Internet connection, for downloading sound tracks files previously stored at the remote location 150 to any one of skating locations 100a,b,c upon request from any of the skating locations. This request would typically be made upon a first visit by a particular skater to a particular skating location 100a,b,c. The download request can be made by a staff person at the skating location via the local server 140 and will normally include the particular visiting skater's skater ID or skater's name. A central skater identification data base 134 may be located at the server location 150, combining the data of the local skater identification data bases of each of the skating locations 100a,b,c. In response to such request, the sound track files personal to that visiting skater located on the central storage system 132 and downloaded from the remote server location 150 for storage on a local storage 138 at the requesting skating location, where locally stored sound tracks remain available for subsequent playback in response to future skater ID input at that skating location 100a,b,c without repeated downloading from the remote server location 150.

Each skating location 100 has a local sound system 120 including loud speakers 122 audible to skaters on a skating rink 14 at that location. A skater identification station 128 is provided at each skating location 100 for receiving skater ID input provided by visiting skaters. The sound system 120 is connected for playing back sound tracks stored in the local file storage 138 in response to entry of corresponding skater ID input provided to skater identification station 128 by a visiting skater. Sound tracks stored on local storage system 138 which are not accessed for some predefined period of time may be periodically purged from the local storage system.

As in the system of FIG. 2, skaters visiting any skating location 100a,b,c may bring their personal skating music on cassette or other portable media for uploading to the local sound track storage 138 of each skating location 100a,b,c via a local sound track upload station 136 provided at each location 100a,b,c. The local sound track upload station 136 may be similar to upload station 36 of FIG. 2. Optionally, the local sound track upload station 136 may be connected via local server 140 for uploading personal music soundtracks to remote central storage 132 via remote server 130. Such uploading to central storage 132 makes the personal sound tracks available for subsequent downloading to any other skating locations 100a,b,c, thereby making personal skating music available for downloading at other skating locations for use by skaters traveling to such other skating locations 100a,b,c.

In an alternate form of the invention, the sound track files are downloaded from the central storage 138 on the remote server 130 in response to each skater ID input, for playback at the skating rink locations, rather than storing the sound tracks on a local storage system at the skating rink locations.

Although particular embodiments of the invention have been described and illustrated for purposes of clarity and example, it must be understood that many changes, substitutions and modifications to the disclosed embodiments will be apparent to persons having only ordinary skill in the art, without thereby departing from the scope of this invention as defined by the following claims.

What is claimed is:

1. A system for storing and playing back personal sound tracks on demand by skaters at a skating rink location, comprising:
a skating rink and a sound system audible to skaters on said rink;
a storage system for storing digital sound tracks for playback through said sound system;
a skater identification data base arranged and configured for associating each of said digital sound tracks with a corresponding skater identification;
a skater identification station for receiving a skater identification input; and
a computer connected and configured for playing back said digital sound tracks through said sound system responsive to entry of corresponding skater identification inputs.

2. The system of claim 1 wherein said skater identification station is accessible for operation by a skater on said skating rink.

3. The system of claim 1 further comprising sound recording input system at said skating rink location for converting sound recordings on portable media to digital sound tracks suitable for storage on said storage system.

4. The system of claim 1 further comprising a digital sound track input station located on the premises of said skating rink and connected for uploading sound tracks to said storage system.

5. The system of claim 1 wherein said storage system is connected to a global computer network for uploading digital sound tracks to said local storage system from locations remote thereto.

6. The system of claim 1 wherein said skater identification station comprises a keyboard for manual entry of said skater identification input by a skater at said skating rink location.

7. The system of claim 1 further comprising a playback control station for controlling playback of a digital sound track.

8. The system of claim 7 wherein said playback control station comprises a hand held wireless remote control operative for controlling playback of a digital sound track.

9. The system of claim 7 wherein said playback control station has control of pause, stop, fast forward, rewind, and repeat of a digital sound track.

10. The system of claim 1 wherein said sound track storage is a local sound track storage located at said ice rink location and further comprising a remote digital sound track storage located at a server location remote from said ice rink location and connected for downloading said digital sound tracks to said local sound track storage for subsequent play back through said sound system at said skating rink location.

11. The system of claim 10 further comprising a master skater identification data base installed at said server location.

12. A music distribution system for storing and playing back personal sound tracks on demand by skaters at different skating rink locations, each location having a local sound system audible to skaters on a skating rink at each said location, said music distribution system comprising:
a master file server at a server location having a central file storage for storing sound tracks;
a skater identification data base for associating skater identifications with said sound tracks in said central file storage;
a skater identification station at each said skating rink location for receiving skater identification input; and
a local computer at each said skating rink location networked to said master file server for downloading said sound tracks and for playing back said sound tracks through said local sound system in response to entry of corresponding skater identification input at said skating rink locations.

13. The system of claim 12 wherein said local computer has local file storage for locally storing sound tracks downloaded from said central file storage of said master file server prior to said playback.

14. The system of claim 13 wherein said local computer is connected for playing back sound tracks stored in said local file storage in response to entry of corresponding skater identification input.

15. The system of claim 14 wherein said local computer is networked for uploading of soundtracks for storage on said central file storage of said master file server.

16. A method for providing personal skating music for playback on demand at any of multiple skating rink locations, comprising the steps of:
providing a sound system audible to skaters on a skating rink at each of said locations;
providing a file storage connected for electronically delivering sound tracks to each of said locations;
storing digital sound tracks selected by skaters on said central file storage, each sound track having an associated skater identification;
electronically conveying a skater identification input from any one of said skating rink locations to said central file storage as a request for a corresponding sound track; and
electronically delivering to said any one of said skating rink locations the requested sound track from said central file storage.

17. The method of claim 16 further comprising the step of storing the requested digital sound track in local digital sound track storage at said any one of said skating rink location for future retrieval in response to future skater identification input at the same location.

18. The method of claim 16 further comprising the step of uploading digital sound tracks from any one of said skating rink locations for storage in said central file storage.

19. The method of claim 16 further comprising the step of uploading sound tracks from a location remote to said central file storage and to said skating rink locations for storage in said central file storage.

20. The method of claim 16 further comprising the step of queuing for playback through said sound system digital sound tracks requested by successive skater identification input at any one of said skating rink locations.

21. A method for distributing personal skating music for play back on demand at a plurality of skating rink locations comprising the steps of:
storing skating music tracks selected by individual skaters at a file server location and associating each of said music tracks with a skater identification;
receiving a skater identification input from a skater at a selected skating rink location chosen by the skater and conveying said skater identification input to said server location; and
downloading a skating music track from said server location to said selected skating rink location.

22. A method for providing personal skating music for play back on demand at a skating rink location comprising the steps of:
assigning a unique skater identification to each of a plurality of skaters;
storing a plurality of skating music tracks selected by said skaters and associating each of said music tracks with a corresponding unique skater identification;
receiving a skater identification input from an individual skater present at said skating rink location; and
playing at least one of said skating music tracks associated with said skater identification input through a sound system at said skating rink location.
